(19) United States
(12) Patent Application Publication
(10) Pub. No.: US 2005/0190405 A1
(43) Pub. Date: Sep. 1, 2005

(54) Document conversion method and apparatus

(75) Inventor: Makoto Tomita, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/922,891

(22) Filed: Aug. 23, 2004

(30) Foreign Application Priority Data
Aug. 26, 2003 (JP) 2003-302004

(51) Int. Cl. G06K 15/02; G06F 17/21

(52) U.S. Cl. 358/1.18; 715/523

(57) ABSTRACT

An object of this invention is to properly set conversion parameters while maintaining good operability of drag and drop in converting an original file such as a text file into an electronic original of each page. To achieve this object, according to this invention, a document conversion method of converting an original data file into a document file formed from an electronic original of each page includes a setting step of prompting the user to set conversion parameters for the attributes of the original document file and storing the conversion parameters, and a conversion step of converting the original data file into the electronic original in accordance with a conversion parameter selected from the conversion parameters set in the setting step.

### FIELD OF THE INVENTION

The present invention relates to a document conversion method and apparatus which provide a print setting function for document data generated by, e.g., a document processing program.

### BACKGROUND OF THE INVENTION

Various application programs are provided in accordance with the types of various data because different data types such as a character, table, and image require different structures for defining these data and different editing operations for these data. The user who uses these data must use different applications for different data types such as a character processing program for editing of characters, a spreadsheet program for editing of tables, and an image editing programs for editing of images.

The user generally uses an application program corresponding to each data type. However, a document to be created by the user is usually not a document made up of only one type of data such as only characters, tables, or images, but a document made up of a plurality of types of data such as characters and tables or characters and images. In order to create a document containing a plurality of types of data, the user utilizes the print functions of various applications, prints data by using the applications, and combines printed materials in a desirable order to create a desired document.

The method of printing data by a plurality of applications and combining the data complicates procedures. Thus, there is proposed a document processing system capable of creating and editing a document as a combination of application data created by a plurality of application programs (Japanese Patent Application Laid-Open No. 2003-091384).

In a document process by the document processing system, the user utilizes the print functions of various applications, and converts data into electronic original data (the file of electronic original data will be referred to as a permanent file hereinafter) interpretable by the document processing system by using the applications. The user can create, save, print, or reuse a desired document by the same procedures as those of combining printed materials in a desired order.

In general, the user must perform print operation by designating a dedicated printer driver called an electronic original writer (also called a print data save driver) in order to convert data into electronic original data interpretable by the document processing system. At this time, the size of an original to be converted, the data quality, character font setting, and the like can be set in detail.

It is cumbersome for the user to activate a plurality of applications and perform print operation. To solve this, a drag-and-drop user interface is proposed. The user overlays the display or symbol of application data on the user interface (UI) of the document processing system. In response to this, a corresponding application is automatically activated, and the electronic original writer executes a printing process to create electronic original data without any user operation. The created electronic original data is loaded into the document processing system, and the user can process data created by a plurality of applications as if all the data could be directly processed by the document processing system.

In Japanese Patent Application Laid-Open No. 2003-091384, the form template can be set by the printing application in advance. An electronic original can be created from a document input from an application in accordance with the set form template (output paper size, paper direction, page layout, and printing method).

When electronic original data is created by drag and drop, printing (i.e., creation of electronic original data) by the electronic original writer is automatically executed. The user cannot set detailed settings such as the input size of an original to be converted, data quality, and character font setting. The user must adopt default values given by the operating system or the like.

A user who wants to perform detailed setting in converting application data into an electronic original cannot utilize the convenient drag-and-drop user interface. The user must follow cumbersome procedures of activating respective applications, performing print settings in the electronic original writer, and then printing.

Even if creation of an electronic original is operated from an application in creating an electronic original from a document such as a text file having no character font attribute, a default font given by the operating system (to be referred to as an OS hereinafter) must be employed. To use a font other than the default value of the OS, a document having no character attribute is opened by the document creation application, the font of the document is changed into a font desired by the user, and then the document is converted into an electronic original, resulting in cumbersome procedures.

### SUMMARY OF THE INVENTION

The present invention has been made to overcome the conventional drawbacks, and has as its object to provide a mechanism capable of obtaining an electronic original which satisfies attributes desired by the user by simple operation even when document attributes such as the original size, data quality, and character font setting do not satisfy attributes necessary for creating an electronic original.

To achieve the above object, the present invention has the following steps.

A document conversion method of converting an original data file into a document file formed from an electronic original of each page comprises
a setting step of prompting a user to set conversion parameters and storing the conversion parameters, and
a conversion step of converting the original data file into the electronic original in accordance with a conversion parameter selected from the conversion parameters set in the setting step.

With these steps, when an electronic original is created by, e.g., drag and drop, it can be created in accordance with a conversion parameter group which is desirably set by the user in advance or designated in creation.

Also, the present invention has the following steps.

A document conversion method of converting an original data file into a document file formed from an electronic original of each page comprises
a setting step of prompting a user to set a plurality of sets of conversion parameters in association with attributes of the file and storing the plurality of sets of conversion parameters, and
a conversion step of converting the original data file into the electronic original in accordance with a conversion parameter associated with an attribute of the original data file among the plurality of conversion parameters set in the setting step.

With these steps, when an electronic original is created by drag and drop, it can be created in accordance with a conversion parameter group suited to an original file out of desired settings by the user.

By setting a plurality of sets of conversion parameters in advance together with their use conditions, which of the sets is to be adopted can be automatically decided to eliminate cumbersome setting by the user.

The user can create electronic original data at desired settings while using a convenient drag-and-drop user interface.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram for explaining the configuration of a stand-alone document processing system according to the first embodiment of the present invention;

FIG. 2 is a block diagram for explaining the configurations of a host computer and printer in the document processing system according to the first embodiment of the present invention;

FIG. 3 is a view showing an example of a book file structure according to the first embodiment;

FIGS. 4A and 4B are tables showing an example of book attributes according to the first embodiment;

FIG. 5 is a table showing an example of chapter attributes according to the first embodiment;

FIG. 6 is a table showing an example of page attributes according to the first embodiment;

FIG. 7 is a flowchart for explaining a sequence of opening a book file according to the first embodiment;

FIG. 8 is a view showing an example of a user interface window when a new book file is opened;

FIG. 9 is a view showing an example of a user interface window when an existing book file is opened;

FIG. 10 is a flowchart for explaining a sequence of importing a permanent file to a book file according to the first embodiment;

FIG. 11 is a flowchart for explaining a sequence of converting application data into a permanent file according to the first embodiment;

FIG. 12 is a view showing an example of a job ticket structure;

FIG. 13 is a flowchart for explaining a conversion parameter setting sequence according to the first embodiment;

FIG. 14 is a flowchart for explaining a conversion parameter decision sequence according to the first embodiment;

FIG. 15 is a flowchart for explaining a conversion parameter & use condition setting sequence according to the second embodiment;

FIG. 16 is a flowchart for explaining a conversion parameter decision sequence according to the second embodiment;

FIG. 17 is a table showing an example of saving and setting of conversion parameters and use conditions according to the second embodiment;

FIG. 18 is a flowchart for explaining an automatic conversion parameter decision sequence according to the second embodiment;

FIG. 19 is a flowchart for explaining a conversion parameter setting sequence in creating an electronic original according to the third embodiment;

FIGS. 20A and 20B are views showing examples of a form template according to the embodiment; and

FIG. 21 is a view showing an example of a “new document” dialog according to the embodiment.

### DETAILED DESCRIPTION OF THE PREFERRED EMBODIMENTS

Preferred embodiments of the present invention will be described in detail below with reference to the accompanying drawings.

### Outline of Document Processing System According to First Embodiment

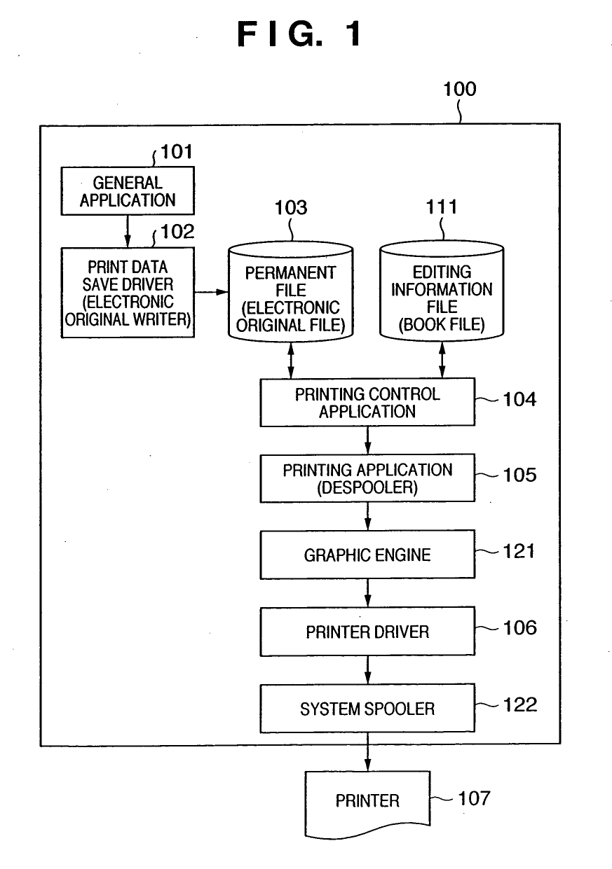

The outline of a document processing system according to the first embodiment of the present invention will be described with reference to FIGS. 1 to 12. In the document processing system, a print data save driver (to be also referred to as an electronic original writer) converts a data file created by a general application into electronic original data, and saves the electronic original data in a permanent file (to be also referred to as an electronic original file). A printing control application (to be also referred to as a bookbinding application) provides a function of editing the permanent file. For a permanent file edited by the printing control application, an editing information file corresponding to the permanent file is generated and saved. The contents of the permanent file are read out and printed by a printing application (also called a despooler) via the printing control application. In this example, a general application, print data save driver, printing control application, and printing application are separately described for distinction between these functions. However, a package provided to the user is not limited to them, and an application or graphic engine as a combination of them may be provided, details of which will be described below.

### Example of Hardware Configuration of Document Processing System According to First Embodiment

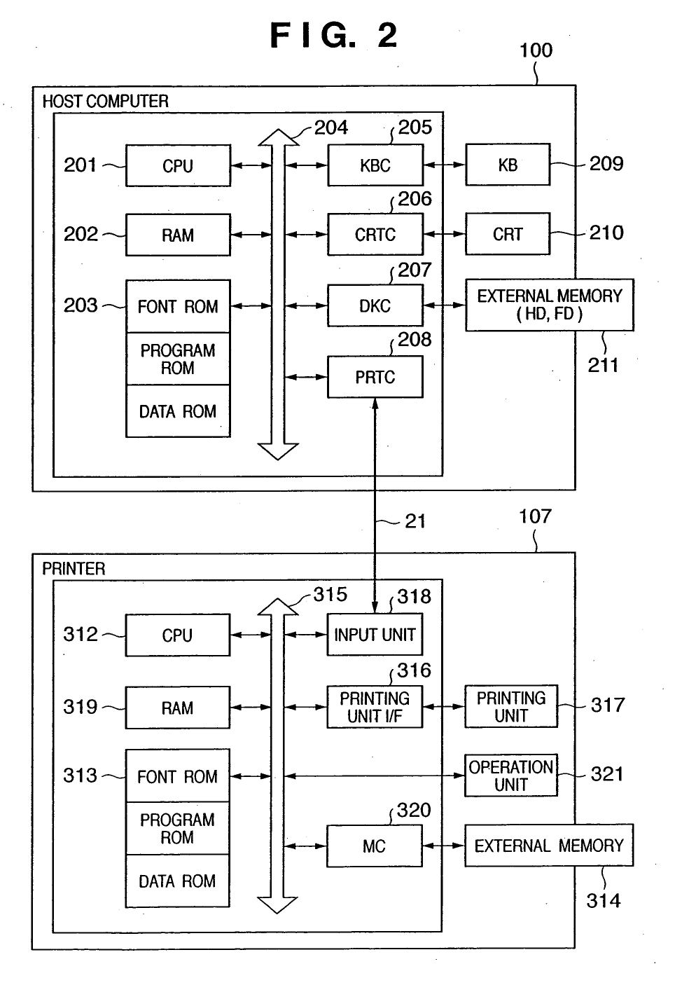

FIG. 2 is a block diagram for explaining the configuration of the document processing system according to the first embodiment. The present invention can be applied to a single apparatus, a system comprised of a plurality of devices, or a system which is connected via a network such as a LAN or WAN and performs processes, as far as the function of the present invention is executed.

In FIG. 2, a host computer 100 comprises a CPU 201, RAM 202, ROM 203, and the like. The CPU 201 executes a document process in which figures, images, characters, tables (including spreadsheets and the like), and the like coexist, on the basis of a document processing program or the like stored in the program ROM of the ROM 203 or an external memory 211. The CPU 201 comprehensively controls devices connected to a system bus 204. The program ROM area of the ROM 203 or the external memory 211 stores, e.g., an operating system program (to be referred to as an OS hereinafter) serving as the control program of the CPU 201. The font ROM area of the ROM 203 or the external memory 211 stores, e.g., font data used in the document process. The data ROM area of the ROM 203 or the external memory 211 stores various data used in the document process or the like. The RAM 202 functions as a main memory, work area, or the like for the CPU 201.

A keyboard controller (KBC) 205 controls a key input from a keyboard 209 or a pointing device (not shown). A CRT controller (CRTC) 206 controls the display of a CRT display (CRT) 210. A disk controller (DKC) 207 controls access to the external memory 211 such as a hard disk (HD) or floppy® disk (FD). The external memory 211 stores a boot program, various applications, font data, user files, edited files, a printer control command generation program (to be referred to as a printer driver hereinafter), and the like. A printer controller (PRTC) 208 is connected to a printer 107 via a bidirectional interface (interface) 21, and executes a communication control process with the printer 107.

The CPU 201 executes, e.g., an outline font rasterization process to a display information RAM set in the RAM 202, and enables WYSIWYG on the CRT 210. The CPU 201 opens various registered windows and executes various data processes on the basis of commands designated on the CRT 210 with a mouse cursor (not shown) or the like. When the user executes printing, he/she opens a print setting window provided by the printer driver, and can perform setting of a printer and setting of a printing process method to the printer driver that includes selection of a print mode.

The printer 107 is controlled by a CPU 312. The printer CPU 312 outputs an image signal as output information to a printing unit (printer engine) 317 connected to a system bus 315 on the basis of a control program stored in the program ROM area of a ROM 313 or a control program stored in an external memory 314. The program ROM area of the ROM 313 stores, e.g., the control program of the CPU 312. The font ROM area of the ROM 313 stores, e.g., font data used to generate the output information. The data ROM area of the ROM 313 stores, e.g., information used in the host computer for a printer having no external memory 314 such as a hard disk.

The CPU 312 can communicate with the host computer via an input unit 318, and notify the host computer 100 of internal printer information or the like. A RAM 319 functions as a main memory, work area, or the like for the CPU 312, and the memory capacity can be expanded by an optional RAM connected to an expansion port (not shown). The RAM 319 is used as an output information mapping area, environment data storage area, NVRAM, or the like. Access to the external memory 314 such as a hard disk (HD) or IC card is controlled by a memory controller (MC) 320. The external memory 314 is connected as an option, and stores font data, emulation programs, form data, and the like. Reference numeral 321 denotes an operation panel having operation switches, an LED display, and the like.

The number of external memories 314 is not limited to one, and a plurality of external memories 314 may be arranged. A plurality of external memories which store an option card and a program for interpreting the printer control languages of different language systems in addition to built-in fonts may be connected. Further, an NVRAM (not shown) may be adopted to store printer mode setting information from the operation unit 321.

### Example of Software Configuration of Document Processing System According to First Embodiment

FIG. 1 is a block diagram showing the software configuration of the document processing system according to the first embodiment.

The document processing system is implemented by a digital computer 100 (to be also referred to as a host computer hereinafter) as an embodiment suited to the document processing apparatus (information processing apparatus) of the present invention. A general application 101 is an application program which provides functions such as wordprocessing, spreadsheet, photo-retouch, draw, paint, presentation, and text editing. The general application 101 has a function of requesting a printing process of an operating system (OS). Such applications utilize a predetermined interface provided by the OS in printing application data such as created document data or image data. To print created data, the application 101 transmits an output command in a predetermined format to the output module of the OS providing the interface. The output module which has received the output command converts it into a format processible by an output device such as a printer, and outputs the converted command. Since the format processible by the output device changes depending on the type of device, the manufacturer, and the model, a device driver is provided for each device. The OS converts a command by using the device driver, generates print data, and combines print data by JL (Job Language) to generate a print job.

When the OS is Microsoft Windows®, the output module is a GDI (Graphic Device Interface) module. The application 101 calls a GDI function by using the created data as a parameter of a format complying with the GDI. As a result, the above-described output command is sent to the OS.

A print data save driver 102 is an improvement of the above-mentioned device drivers, and is a software module provided to implement the document processing system. The print data save driver 102 does not target a specific output device, and converts an output command into a format processible by a printing control application 104 or a printer driver 106 (to be described later). The format (to be referred to as a “permanent file format” hereinafter) converted by the print data save driver 102 is not particularly limited as far as the document structure and each original page can be expressed by a detailed format. As the format which expresses each original page, the PDF (Portable Document Format) format by Adobe Systems and the SVG (Scalable Vector Graphics) format can be adopted as permanent files.

In the first embodiment, a permanent file 103 and editing information file 111 are processed as separate files, but when no file is opened, are combined as an archive file in order to hold the unity. In this description, the permanent file 103 and editing information file 111 may also be called an electronic original file at once. The print data save driver may also be called an electronic original writer which means a program for generating an electronic original file.

In the system shown in FIG. 1, data contents saved in the permanent file 103 can be processed. This realizes a function not provided to an application, such as a function of enlarging/reducing print data from an application or a function of reducing a plurality of pages into one page and printing the page. For this purpose, the system in FIG. 1 is expanded from a conventional one so as to spool intermediate code data. A print data process is generally set through a window provided by the printing control application 104, and the setting contents are saved in the RAM 202 or external memory 211.

As shown in FIG. 1, according to the extended processing method, print data from the application 101 is saved as the permanent file 103 in the system via the print data save driver 102. The permanent file 103 is also called an intermediate file, and contains content data of a print material, print setting data, and the like. Content data of a print material is data prepared by converting data created in an application by the user into an intermediate code. Print setting data is data which describes how to output content data (output form or the like). In addition, the permanent file 103 contains application extension data called an editing information file for providing a user interface when the printing control application prompts the user to edit the contents of a permanent file or issue an output instruction. The editing information file 111 stores not only extension data for providing a user interface, but also print setting data which cannot be stored in a permanent file. The editing information file 111 can also save print settings which cannot be saved in a standard format when the permanent file adopts the standard format.

The permanent file 103 is loaded into the printing control application 104. The printing control application 104 maps the contents of the permanent file 103 into a table in the memory. If the editing information file 111 contains unique settings which are not stored in the permanent file, the printing control application 104 reflects the settings in the table mapped in the memory. The printing control application 104 can change, display, save, and print the output form of the contents of the loaded permanent file 103. A printing process is actually executed by the printing application (despooler) 105. The printing application (despooler) 105 which has received a printing command from the printing control application 104 inputs data to a graphic engine 121 in a predetermined format such as a GDI function in accordance with the output form set by the printing control application 104. The graphic engine 121 converts the input data of the GDI function format or the like into a DDI function, and outputs the DDI function to the printer driver 106. The printer driver 106 generates a printer control command of the page description language or the like on the basis of the DDI function acquired from the graphic engine 121, and outputs the command to the printer 107 via a system spooler 122.

### Example of Data Format of Permanent File

Before a detailed description of the printing control application 104, the data format of the permanent file will be described. The permanent file contains data of each original page (data of each page generated by an application: to be also referred to as a logical page) as content data, and data of a job ticket format as print setting data. The editing information file 111 to be separately referred to by the printing control application 104 (to be described later) is also stored together with the permanent file 103. In the permanent file 103, original page data of the PDF format and data of the job ticket format are intermediate data.

In the permanent file, original page data is defined by the PDF format or the like, and contains designation of the character font and color, and layout information of characters, figures, and the like within an original page.

A job ticket saved as a permanent file is data having a structure whose minimum unit is an original page. The structure of the job ticket defines the layout of an original page on a paper sheet. One job ticket corresponds to one print job. The node of the whole document is set at the top of the structure, and defines the attribute of the whole document such as double-sided printing/single-sided printing. This node is accompanied with a document structure and information representing setting of each building component. More specifically, a sheet bundle node belongs to the document node, and contains attributes such as the identifier of paper for use and designation of a feed port in the printer. The node of a sheet contained in the sheet bundle belongs to each sheet bundle node. One sheet corresponds to one paper sheet. A print page (physical page) belongs to each sheet. One physical page belongs to one sheet in single-sided printing, and two physical pages belong to one sheet in double-sided printing. An original page to be laid out on a physical page belongs to the physical page. The physical page attribute contains an original page layout. An original page contains association information (link information) to original page data which is the entity of the original page.

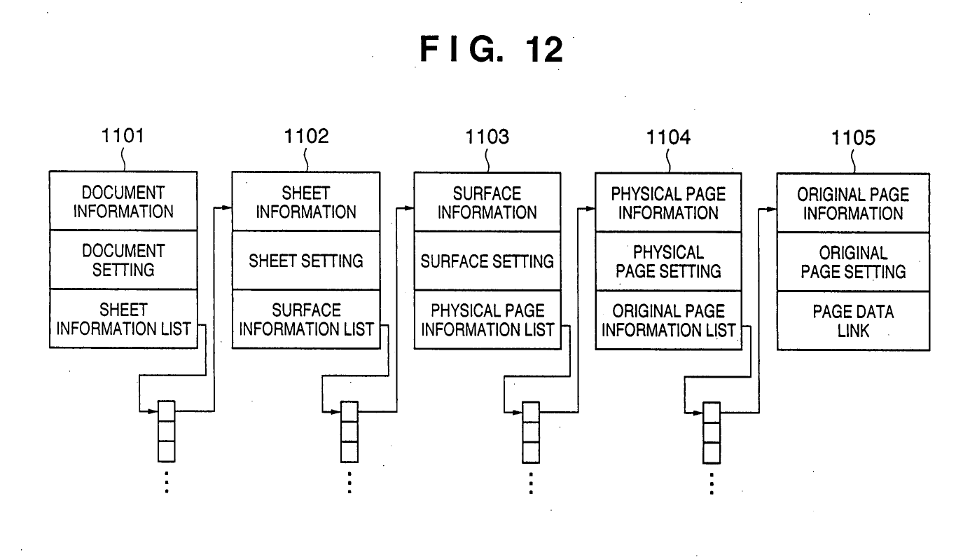

FIG. 12 shows an example of the data structure of a job ticket. In print data, a document is formed by a set of sheets, and each sheet is formed by two, upper and lower surfaces. Each surface has a region (physical page) for laying out an original, and each physical page is formed by a set of original pages serving as minimum units. Reference numeral 1101 denotes data corresponding to a document. The data 1101 is made up of data on a whole document and a list of sheet information forming the document. Sheet information 1102 is formed by information on a sheet such as the sheet size, and a list of surface information laid out on the sheet. Surface information 1103 is formed by data unique to a surface, and a list of physical pages laid out on the surface. Physical page information 1104 is formed by information such as the size and header/footer of a physical page, and a list of original pages which form the physical page. Original page information 1105 contains settings of an original page and a link to page data representing the contents of the page.

Settings of the whole document include pieces of following information.
(1) Layout information (e.g., so-called N-up print setting of laying out N pages on one physical page) and order of original pages on a physical page (sheet surface of a print medium)
(2) Document name
(3) Double-sided designation or not
(4) Variable printing (technique of embedding separately prepared data in the contents of a predetermined column and printing the resultant data) or not
(5) The number of contained original pages
(6) Color type
(7) The number of copies, etc.
(8) Watermark (ground pattern superposed on an original page or print page)
   (9) Printer state
(10) Medium type
(11) Logical page number list on a sheet
(12) Print quality, etc.

As for print settings of each sheet bundle, the following parameters can be set.
(13) Designation of N-up printing
(14) Color type
(15) Paper source

As for print settings of each sheet belonging to each sheet bundle, the following parameter can be set.
(16) Setting of double-sided/single-sided printing

As for print settings of each physical page (surface) belonging to each sheet, the following parameters can be set.
(17) Color type
(18) Designation of an upper or lower surface

As for print settings of each original page laid out on each physical page, the following parameters can be set.
(19) Start coordinates
(20) Size
(21) Order

In this manner, the job ticket is data having a hierarchical structure whose minimum unit is an original page. Most of print settings defined by the job ticket are common on each layer set for each document, but some print settings such as N-up setting and color type are common between layers. In principle, as for a common setting, a lower layer inherits the same setting value as that of an upper layer. When an attribute common between layers has different values, a value set for a layer of interest is used as the value of the attribute. For example, the color type can be set for a whole document, sheet bundle (set of sheets), and physical page (to be also referred to as a surface or print page). The color type is a setting which designates a mode in the printing apparatus. Print data is generated so that, if the monochrome mode is set, the printing apparatus prints in monochrome, and if the color mode is set, prints in color.

### Document Structure Managed by Editing Information File

The printing control application 104 is a program which provides a user interface for prompting the user to designate data contained in the permanent file 103 by various methods and change print settings. The permanent file is a file having the above-described structure. Separately from the permanent file 103, the printing control application 104 manages the above-mentioned editing information file 111 in correspondence with the permanent file. Based on editing information contained in the editing information file, the printing control application 104 manages a document with a management structure independent of a document defined by the permanent file 103, e.g., a job ticket. The management structure is a hierarchical structure similar to the job ticket, but is formed by layers “book”, “chapter”, and “original (logical) page” from the top, unlike the job ticket. Of these layers, the original page corresponds to the original page of the job ticket. The chapter corresponds to the sheet bundle (set of sheets).

A document file displayed as a user interface is temporarily constructed for a user interface when the user changes the print settings of the permanent file 103 or designates printing by using the printing control application 104. The printing control application 104 opens the permanent file 103 together with a corresponding editing information file 111, and maps from the permanent file in a memory a despool table (to be described later) having a structure defined by the editing information. The printing control application 104 displays the document file structure and preview window as a user interface on the basis of the despool table, which will be described later. The document file which is constructed by the printing control application (bookbinding application) 104 on the basis of the permanent file 103 and editing information file 111 will be called a book file. When the editing information file has unique setting items, the user can change print settings while referring to the book file via the user interface. Changed settings are reflected in the table (despool table) in the memory, and if saving of the changed settings is designated, saved in the permanent file 103 and editing information file 111.

### Example of Format of Editing Information File

Before referring to details of the printing control application 104, the data format of a book file, i.e., editing information file will be explained. The book file has a three-layered structure similar to a paper-medium book. The upper layer is called a “book”, resembles one book, and defines the attributes of the entire book. The intermediate layer corresponds to a chapter in the book, and is also called a “chapter”. As for each chapter, its attributes can be defined. The lower layer is a “page”, and corresponds to each page defined by an application program. As for each page, its attributes can be defined. One book may contain a plurality of chapters, and one chapter may contain a plurality of pages.

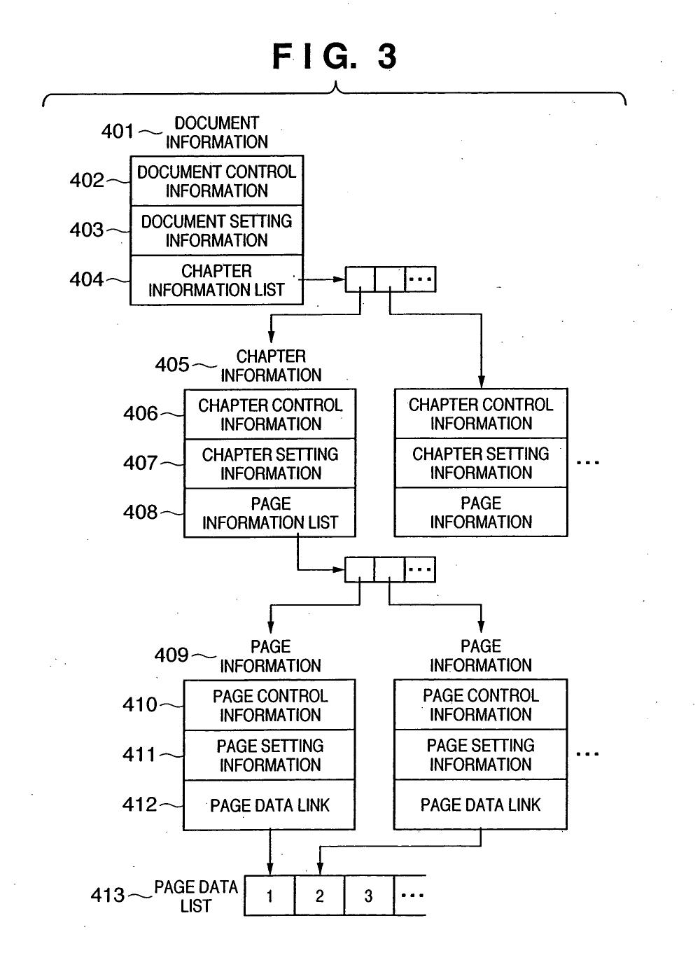

FIG. 3 is a block diagram schematically showing an example of the book file format. A book, chapter, and page in the book file of this example are represented by corresponding nodes. One book file contains one book. The book and chapter are a concept for defining a book structure, and contain, as entities, defined attribute values and links to lower layers. The page entity is original page data of the PDF format or the like which is contained in the permanent file 103. That is, the editing information file 111 only defines the book file format and attributes, and does not contain original page data itself. The page has, as entities, data of each page output from an application program. The page contains an original page entity (original page data) and a link to each original page data in addition to an attribute value. Note that a print page to be output to a paper medium may contain a plurality of original pages. This structure is displayed not by a link, but by attributes in book, chapter, and page layers.

In FIG. 3, a book file need not be one completed book, and “book” is generalized as “document”. Information on a document, information on a chapter, and information on a page will be comprehensively called document information, chapter information, and page information, respectively.

In FIG. 3, document information 401 is defined at the top. The document information 401 can be roughly divided into three parts 402 to 404. The document control information 402 holds information such as the path name in the file system of a document file. The document setting information 403 holds layout information such as the page layout, and function setting information of a printing apparatus such as stapling, and corresponds to book attributes. The chapter information list 404 holds as a list a set of chapters which form a document. The list holds chapter information 405.

The chapter information 405 can also be roughly divided into three parts 406 to 408. The chapter control information 406 holds information such as the chapter name. The chapter setting information 407 holds information on the page layout and stapling unique to the chapter, and corresponds to chapter attributes. By holding setting information for each chapter, a document having a complicated layout can be created such that the first chapter has a 2-up layout and the remaining chapters have a 4-up layout. The page information list 408 holds as a list a set of original pages which form each chapter. The page information list 408 designates page information data 409.

The page information data 409 can also be roughly divided into three parts 410 to 412. The page control information 410 holds information such as a page number displayed at the tree. The page setting information 411 holds information such as the page rotation angle and page layout position information, and corresponds to original page attributes. The page link information 412 is original data corresponding to a page. In this example, the page information 409 does not directly have original data, but has only the link information 412. Actual original data is held by a page data list 413.

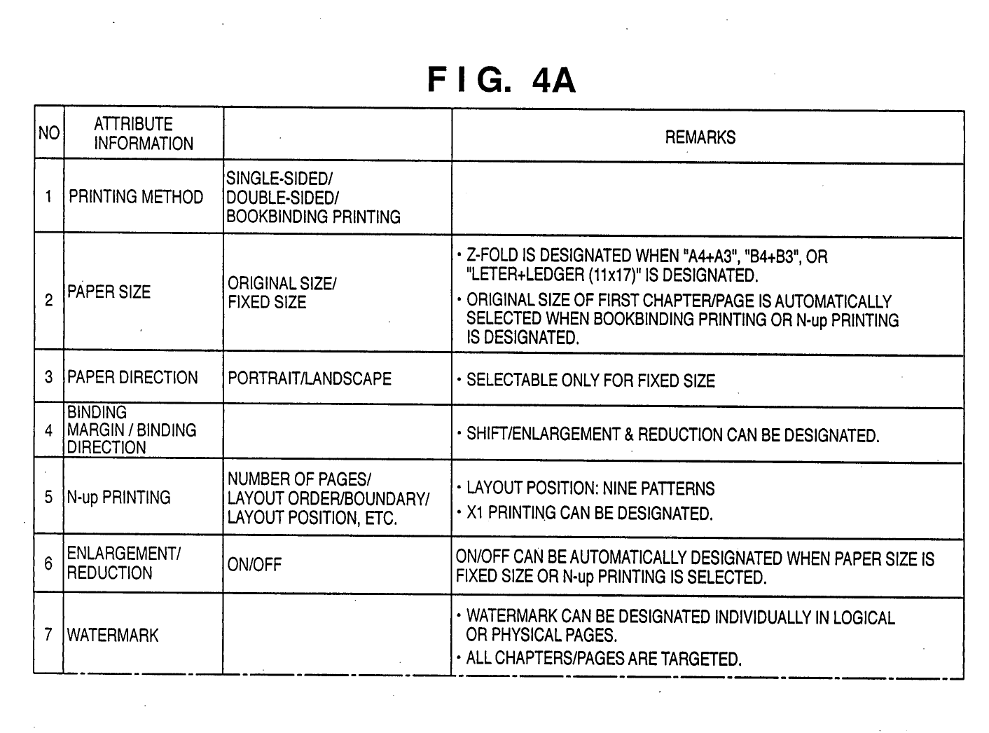

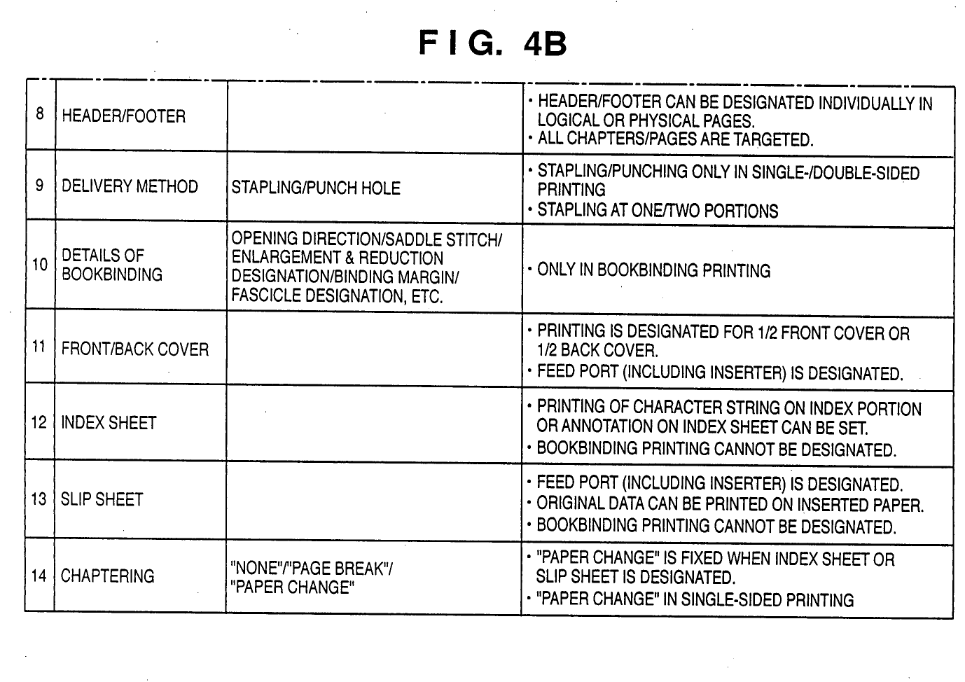

FIGS. 4A and 4B are tables for explaining a book attribute 301 according to the first embodiment. In FIGS. 4A and 4B, as for an item which can be defined repetitively on a lower layer, the attribute value of the lower layer is preferentially adopted. As for an item contained in only the book attribute 301, a value defined in the book attribute 301 is effective throughout the book. An item repetitively defined on a lower layer is a default value used when this item is not defined in the lower layer. Each item shown in FIGS. 4A and 4B does not correspond to one concrete item, but may contain a plurality of relevant items.

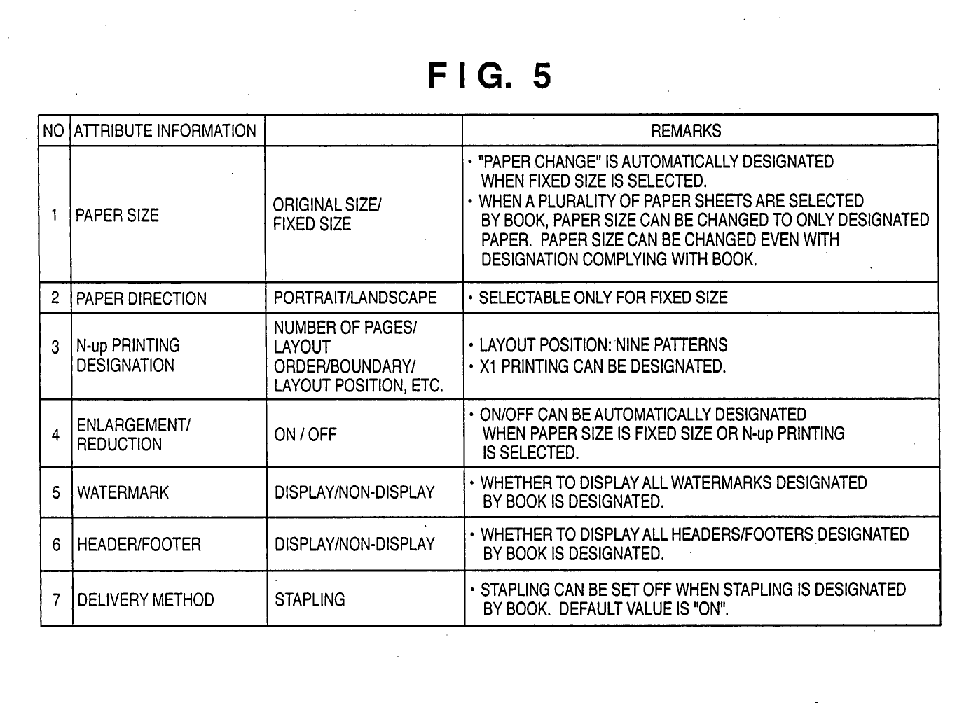

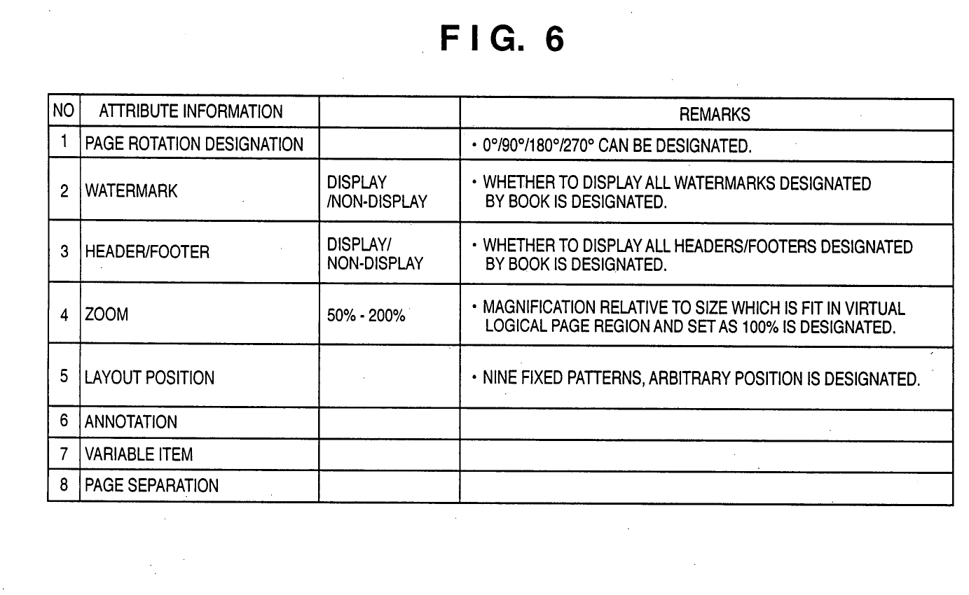

FIG. 5 is a table for explaining a chapter attribute according to the first embodiment. FIG. 6 is a table for explaining a page attribute according to the first embodiment. The relationship between the chapter attribute and the page attribute is the same as that between the book attribute and the lower layer attribute.

In FIG. 4, items unique to the book attribute 301 are six items “printing method”, “details of bookbinding”, “front/back cover”, “index sheet”, “slip sheet”, and “chaptering”. These items are defined throughout the book.

As the “printing method” attribute, three values “single-sided printing”, “double-sided printing”, and “bookbinding printing” can be designated. “Bookbinding printing” is a method of printing in a format which allows bookbinding by bundling a separately designated number of paper sheets, folding the bundle into two, and binding the bundle. As the “detailed bookbinding” attribute, “opening direction” and “the number of paper sheets to be bundled” can be designated when “bookbinding printing” is designated as “printing method”.

The “front/back cover” attribute includes designation of adding paper sheets serving as front and back covers when an electronic original file combined as a book is printed, and designation of contents to be printed on the added paper sheets. The “index sheet” attribute includes designation of inserting a tabbed index sheet separately prepared in a printing apparatus for chaptering, and designation of contents to be printed on the index (tabbed) portion. This attribute becomes effective when a printing apparatus for use is equipped with an inserter having an inserting function of inserting a paper sheet prepared separately from a print sheet into a desired position, or when a plurality of sheet cassettes can be used. This also applies to the “slip sheet” attribute. The “slip sheet” attribute includes designation of inserting a paper sheet fed from an inserter or sheet feed cassette for chaptering, and designation of a sheet feed source when a slip sheet is inserted.

The “chaptering” attribute includes designation of whether to use a new paper sheet, use a new print page, or do nothing particular at a chapter break. In “single-sided printing”, the use of a new paper sheet and the use of a new print page are the same. In “double-sided printing”, successive chapters are not printed on one paper sheet if “the use of a new paper sheet” is designated, but may be printed on the obverse and reverse of one paper sheet if “the use of a new print page” is designated.

As for the chapter attribute shown in FIG. 5, there is no item unique to the chapter, and all items overlap those of the book attribute. If the definition of the chapter attribute is different from that of the book attribute, a value defined by the chapter attribute precedes. Items common to only the book and chapter attributes are five items “paper size”, “paper direction”, “N-up printing designation”, “enlargement/reduction”, and “delivery method”. The “N-up printing designation” attribute is an item for designating the number of original pages contained in one print page. Layouts which can be designated are 1×1, 1×2, 2×2, 3×3, 4×4, and the like. The “delivery method” attribute is an item for designating whether to staple discharged paper sheets. The effectiveness of this attribute depends on whether a printing apparatus for use has a stapling function.

As for the page attribute shown in FIG. 6, items unique to the page attribute are “page rotation designation”, “zoom”, “layout designation”, “annotation”, and “page separation”. “Page rotation designation” is an item for designating the rotation angle when an original page is laid out on a print page. The “zoom” attribute is an item for designating the zoom ratio of an original page. The zoom ratio is designated based on a virtual logical page region size=100%. The virtual logical page region is a region occupied by one original page when original pages are laid out in accordance with N-up designation or the like. For example, the virtual logical page region is a region corresponding to one print page for 1×1, and a region obtained by reducing each side of one print page to about 70% for 1×2.

Attributes common to the above-mentioned “book”, “chapter”, and “page” are a “watermark” attribute and “header/footer” attribute. “Watermark” is a separately designated image or character string printed over data created by an application. “Header/footer” is a watermark printed at the upper or lower margin of each page. For “header/footer”, items such as a page number, and time and date which can be designated by variables are prepared. Contents which can be designated by the “watermark” attribute and “header/footer” attribute are common between “chapter” and “page”, but are different from those of “book”. “Book” can set the “watermark” and “header/footer” contents, and designate how to print “watermark” or “header/footer” throughout the book. To the contrary, “chapter” and “page” can only designate whether to print “watermark” or “header/footer” set by the book on the chapter or page.

### Example of Operation Sequence of Document Processing System According to First Embodiment

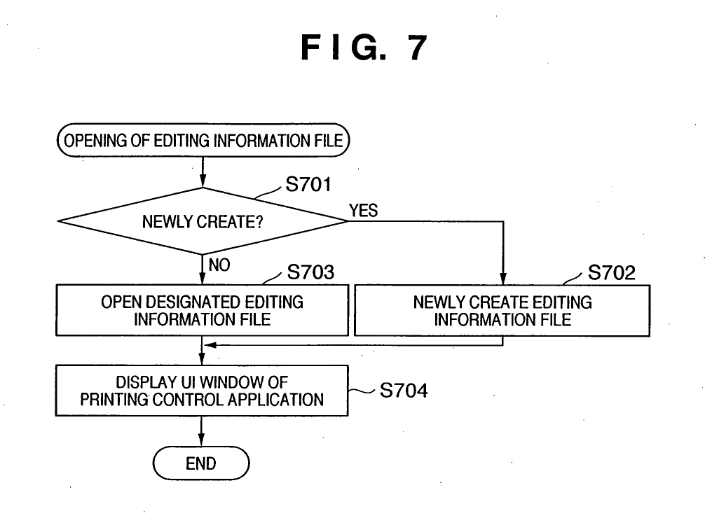

The editing information file has the above-described structure and contents. A sequence of creating the editing information file 111 and permanent file 103 by the printing control application 104 and print data save driver 102 will be explained. Creation of the editing information file 111 is realized as part of editing operation of the editing information file 111 by the printing control application 104. FIG. 7 shows a sequence when the printing control application 104 opens the permanent file 103 and editing information file 111 and maps them in the memory.

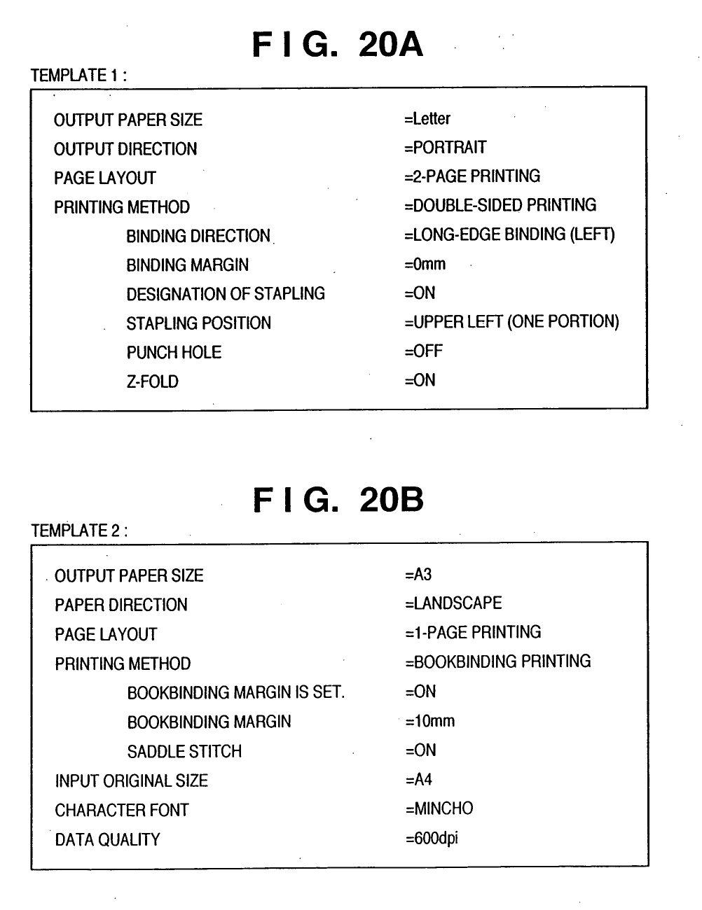

In step S701, the printing control application 104 determines whether a book file to be opened is one to be newly created or an existing one. If the book file is one to be newly created, the flow advances to step S702 to newly create a book file containing no chapter. In the example shown in FIG. 3, the newly created book file is a book node having only the document information node 401 and having no link to a chapter information node. An attribute set (FIG. 20) selected by user operation from a plurality of attribute sets prepared in advance for creation of a new file is applied as the book attribute in this case. The process advances to step S704 to display a user interface (UI) window for editing the new book file.

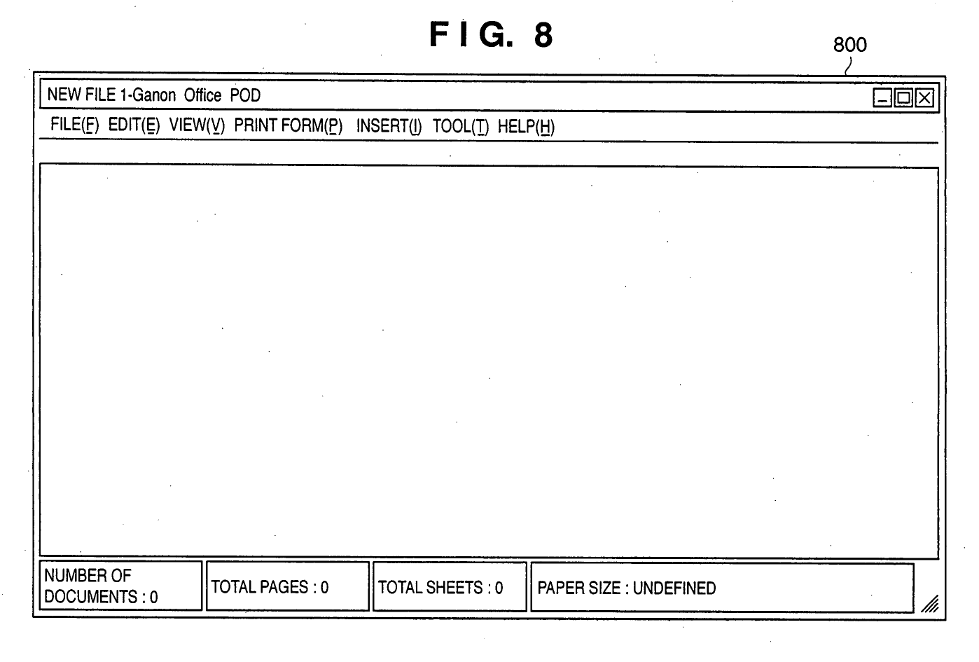

FIG. 8 is a view showing an example of a UI window when a book file is newly created. In this case, the book file does not have any substantial content, and a UI window 800 does not display anything. A document can be loaded by dragging and dropping a predetermined document file to a book file (electronic original) having no substantial content, as shown in FIG. 8.

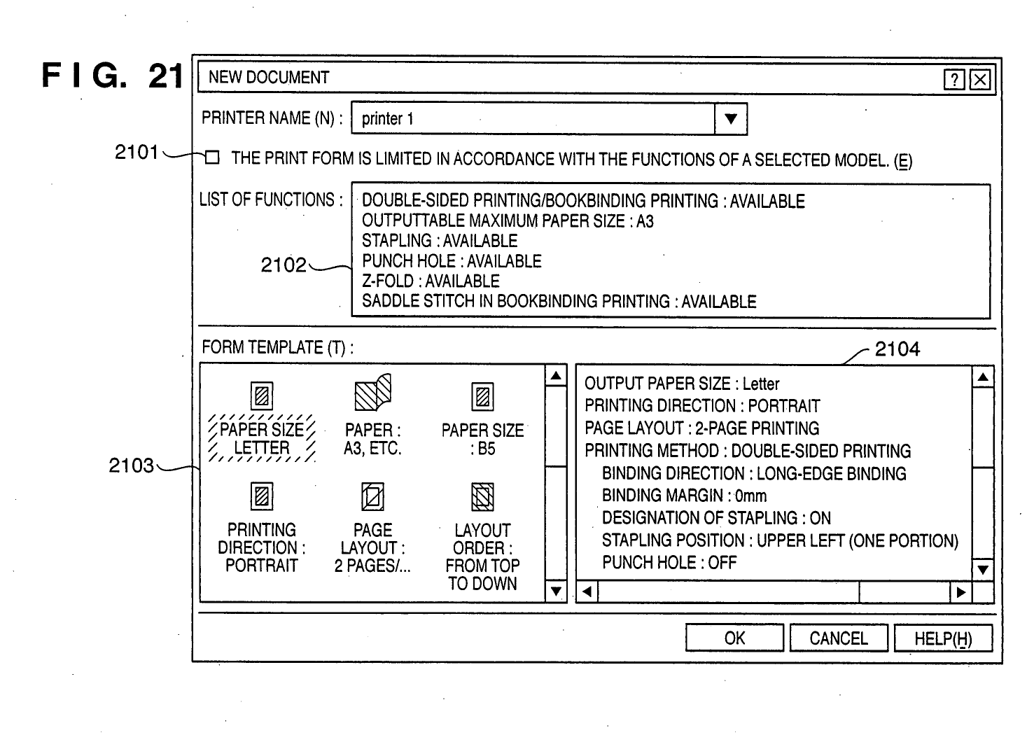

FIGS. 20A and 20B show form templates as attribute sets prepared in advance. The form template according to the present invention includes a form template which describes a print form, as shown in FIG. 20A, and a form template which describes not only the print form but also document attributes such as the input original size, character font, and data quality, as shown in FIG. 20B. A template for use can be selected in advance by user operation on the user interface of the printing control application 104, as shown in FIG. 21. When the template in FIG. 20B with document attributes is selected and a document such as a text document having no document attribute is loaded by drag and drop, the attributes of the document can be reflected as attributes described in the template, which will be described later.

If the book file is an existing one in step S701, the flow advances to step S703 to open a designated book file and display a user interface (UI) window in accordance with the structure, attributes, and contents of the book file.

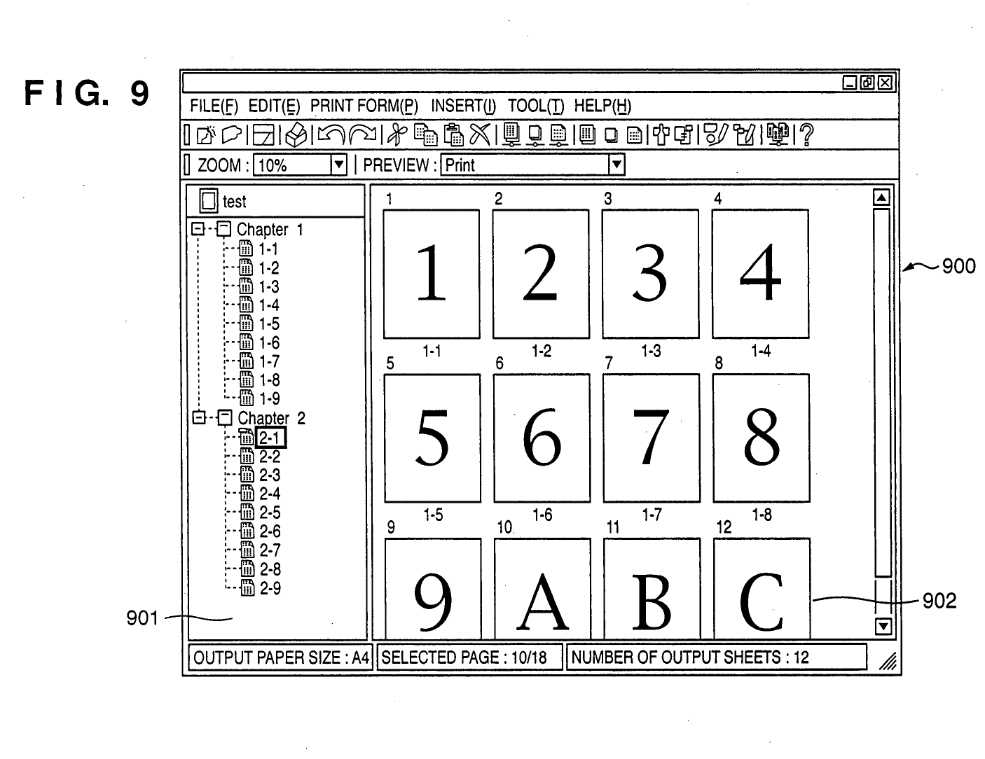

FIG. 9 is a view showing an example of the displayed UI window. A UI window 900 has a tree portion 901 representing a book structure, and a preview portion 902 displaying a state to be printed. The tree portion 901 displays chapters contained in the book and pages contained in each chapter by a tree structure as shown in FIG. 3. Page numbers are displayed at the tree portion 901, and represent the numbers of original pages. The preview portion 902 displays reduced print page contents. The display order reflects the book structure.

Application data converted into the permanent file 103 can be added as a new chapter to the open book file by the print data save driver 102. This function is called an “electronic original import function”. The electronic original is imported to the book file newly created by the sequence shown in the flowchart of FIG. 7, giving an entity to the book file. This function is activated by dragging and dropping application data in the window of FIG. 8 or 9.

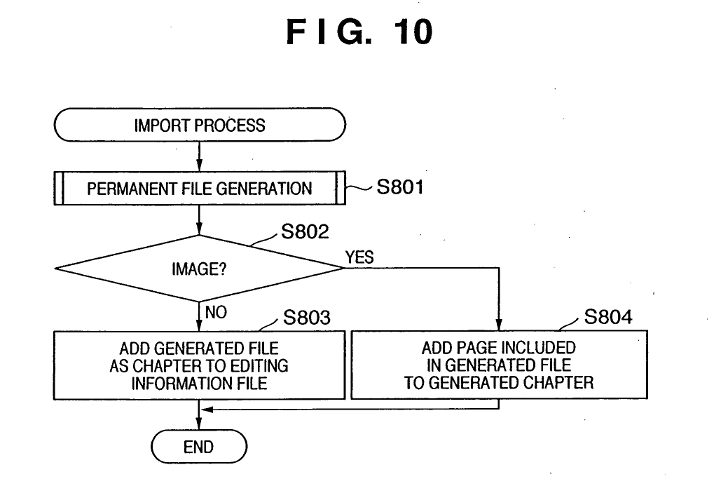

FIG. 10 is a flowchart showing an electronic original import sequence according to the first embodiment.

An application program which has generated designated application data is activated. The print data save driver 102 is designated as a device driver, and application data is printed out to convert the data into data of an intermediate format (e.g., PDF format) (step S801). After conversion, whether the converted data is image data is determined (step S802). This determination can be done on the basis of the file extension of application data under the Windows® OS. For example, an extension “bmp” represents Windows® bitmap data; “jpg”, jpeg-compressed image data; and “tiff”, tiff-format image data.

If the data is not image data, the intermediate data generated in step S801 is added as a new chapter to the book of a currently open editing information file 111 (step S803). That is, a new chapter and new original pages belonging to this chapter are added by import. Link information to the entity of an original page is written at each page node. The entity of the original page is generated by the print data save driver 102.

In import, as for chapter attributes which are common to book attributes, the values of the book attributes are copied. As for unique chapter attributes, predetermined default values are set. As for chapter attributes which are common to the attributes of the whole document of the permanent file, the values of the document attributes are inherited.

If the imported application data is image data, no new chapter is added in principle, and image data is added to a designated chapter by using one file as one original page (step S804). For an empty file in which an editing information file 111 is newly created, a new chapter is created, and image data is added as an original page belonging to the chapter. As for page attributes, attributes common to the attributes of an upper layer are given the attribute values of the upper layer, and attributes which are defined in application data and inherited to the permanent file 103 are given values defined in the application data. For example, when N-up designation is defined in application data, the page inherits this attribute value. In this way, a new editing information file is created, or a new chapter is added.

As for the permanent file 103, added original page data is newly added and saved if data generated by the print data save driver 102 is an addition to the existing permanent file 103. At this time, if print settings designated by the application 101 are reflected in data generated by the print data save driver 102, the print settings can also be reflected in the permanent file 103.

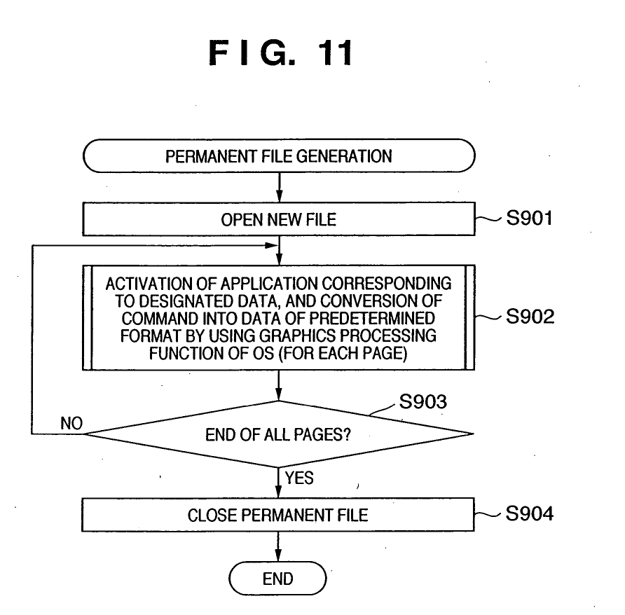

FIG. 11 is a flowchart showing a sequence of generating a permanent file 103 by the print data save driver 102 in step S801 of FIG. 10. A new permanent file 103 is created and opened (step S901). An application corresponding to designated application data is activated. The print data save driver 102 is set as a device driver to transmit an output command to an OS output module (e.g., Windows® GDI). The output module converts the received output command into data of a predetermined format (e.g., PDF format) by the print data save driver 102, and outputs the converted data (step S902). The output destination is the permanent file opened in step S901. Whether all designated data have been converted is determined (step S903), and if YES in step S903, the permanent file is closed (step S904). The permanent file generated by the print data save driver 102 is a file called a job thicket which contains a structure shown in FIG. 12 and original page data entities.

### Parameter Setting in Conversion into Electronic Original Data

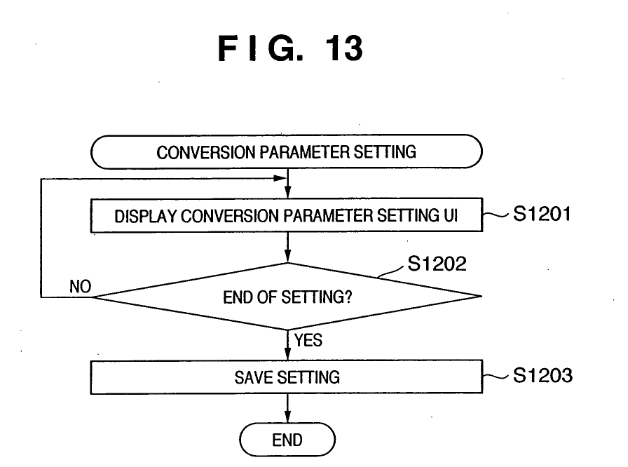

FIG. 13 is a flowchart showing a conversion parameter setting process when the print data save driver 102 can set details of conversion operation in conversion operation of step S902. When the user wants to create electronic original data by designating details of conversion operation, e.g., “paper size”, “paper direction”, “margin”, “resolution”, “font”, “compression operation”, “drawing operation”, and “color”, conversion parameters are designated using a conversion parameter setting UI at an arbitrary timing in advance. This process is shown in FIG. 13. The user designates to display a conversion parameter setting UI (FIG. 21) from a bookbinding application UI, and starts setting (S1201). For example, “electronic original data conversion parameter” is added as a submenu to “print form” from the menu column of the user interface window in FIG. 8 or 9. The user interface in FIG. 21 is displayed from “electronic original data conversion parameter” to prompt the user to set a template for use.

The user interface window provides columns displaying conversion parameter items such as names “output paper size”, “paper direction”, “margin”, “resolution”, “input original size”, “font”, “compression operation”, “drawing operation”, and “color”, and input columns corresponding to the display columns. Each input column displays the setting value of a corresponding item that is stored in a memory or hard disk and read out from it. The default values of these items are those held by the operating system. For items not held by the operating system, default values unique to the bookbinding application are set in advance. Default values are defined such that, for example, the input original size is A4 size, the paper direction is “portrait”, the resolution is 600 dpi, and the font is a predetermined font held by the operating system or a font directly designated by the user. These setting values may be displayed on the UI of the print data save driver 102 to prompt the user to input values. The user interface (FIG. 21) is unique to the print data save driver 102, and the user is prompted to input various setting values as parameters in converting application data into electronic original data. Setting items and their input method are the same as those in setting on the user interface of the bookbinding application.

If the user ends setting (S1202), the bookbinding application or print data save driver 102 records setting values designated by the user as conversion parameters in the HD (211) or RAM (202) (S1203).

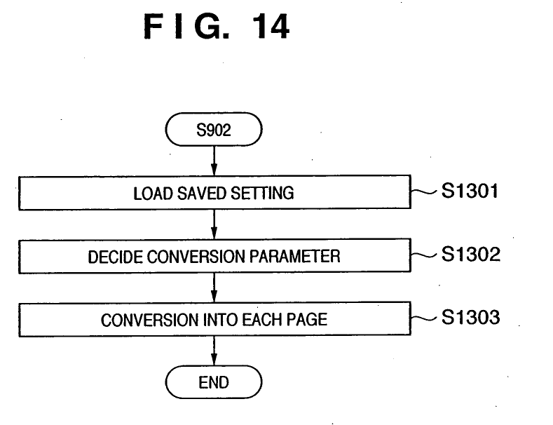

FIG. 14 shows the contents of step S902 in FIG. 11. In conversion operation of step S902 by the print data save driver 102, the print data save driver 102 loads values (contents of the template shown in FIG. 20A or 20B) set by the user, as shown in FIG. 14 (step S1301). Parameters in conversion are decided in accordance with the settings (S1302). The print data save driver 102 generates electronic original data in accordance with the decided conversion parameters (S1303).

The electronic original data can adopt, e.g., the PDF format. For example, PDF data contains a font, and designates the font, size, position, and color of characters contained in the document. For example, when text data is converted into PDF data, a font designated by the user is embedded in a permanent file after conversion because the text merely has a string of character codes. Further, the definitions of the character size, color, position, and the like which are designated by the user for characters are embedded in accordance with the PDF format.

If electronic original data is described by the SGML, a designated font, color, and position are embedded in converted data in accordance with user setting by using SGML tags.

When the default value of the paper size is A4 but the user selects B4 size in advance in the setting of FIG. 13, the print data save driver 102 converts application data into electronic original data by drag-and-drop operation in accordance with the setting value input by the user without setting the paper size again by the user. The electronic original data can be generated with more preferable user settings.

In this manner, electronic original data is created for each page, and a permanent file and editing information file in which electronic original data of each page is contained as a page are created.

### Editing of Editing Information File

As described above, the editing information file 111 and permanent file 103 can be created from application data. In the editing information file 111, chapters and pages can be edited as follows.
(1) New document
(2) Delete
(3) Copy
(4) Cut
(5) Paste
(6) Move
(7) Change chapter name
(8) Reassign page number/name
(9) Insert cover
(10) Insert slip sheet
(11) Insert index sheet
(12) Page layout of each original page

In addition, an operation of canceling executed editing operation, and an operation of restoring canceled operation can be performed. These editing functions enable editing operations such as consolidation of a plurality of editing information files, rearrangement of chapters and pages within an editing information file, delete of chapters and pages within an editing information file, layout change of an original page, and insertion of a slip sheet and index sheet. By these operations, operation results are reflected in attributes shown in FIGS. 4A to 6 or in the structures of the permanent file 103 and editing information file 111. For example, a blank page is inserted to a designated portion by an operation of newly adding a blank page. The blank page is processed as an original page. If the layout of an original page is changed, the change contents are reflected in attributes such as the printing method, N-up printing, front/back cover, index sheet, slip sheet, and chaptering. Layout editing is reflected in the structure of the job thicket of the permanent file 103.

### Output of Editing Information File

The ultimate goal of an editing information file created and edited in the above manner is to print out the file. If the user selects a file menu from the UI window 900 of the printing control application shown in FIG. 9 and selects printing from this menu, the editing information file is then printed out by a designated output device. At this time, the printing control application 104 creates data called the above-mentioned despool table from a currently open editing information file and corresponding permanent file (e.g., job ticket), and transfers the despool table to the printing application 105.

The printing application 105 converts the despool table into a parameter to be transferred to the graphic engine 121. The printing application 105 converts the permanent file 103 into an OS output command, e.g., a Windows® GDI command, and calls a GDI function serving as a graphic engine by using the command as a parameter. The graphic engine 121 generates a command complying with an output device (e.g., printer) by the designated printer driver 121, and transmits the command to the output device.

The graphic engine 121 loads the printer driver 106 prepared for each printing device from the external memory 211 to the RAM 202, and sets the output to the printer driver 106. The graphic engine 121 converts a GDI (Graphic Device Interface) function into a DDI (Device Driver Interface) function, and calls a DDI function provided by the printer driver 106. The printer driver 106 converts the command into a control command such as a PDL (Page Description Language) command recognizable by the printer on the basis of the DDI function called from the output module. The converted printer control command passes through the system spooler 122 loaded by the OS to the RAM 202, and is output as print data to the printer 107 via an interface 21.

As described above, according to the invention of the first embodiment, electronic original data in which especially the character attribute is decided in accordance with settings designated in advance by the user can be created in converting application data into electronic original data. The user need not designate setting values, particularly the character attribute every time application data is converted into electronic original data. Conversion operation can be achieved using a convenient drag-and-drop user interface.

### Second Embodiment

In the first embodiment, the user can set only one value for each of items such as “output paper size”, “paper direction”, “margin”, “resolution”, “input original size”, “font”, “compression operation”, “drawing operation”, and “color” in the sequence of generating electronic original file by the electronic original writer 102. In the second embodiment, a proper one of settings can be automatically adopted by recording conversion parameters together with their use conditions and determining a setting use condition in conversion operation of the electronic original writer. The second embodiment will be described in detail below with reference to the accompanying drawings.

The basic configuration is the same as those shown in FIGS. 1, 2 and 11 in the first embodiment. A description of parts having the same configurations as those in the first embodiment will be omitted.

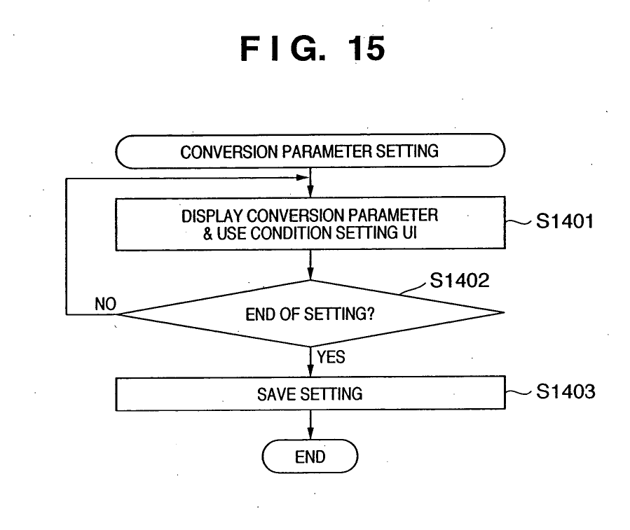

FIG. 15 is a flowchart showing a conversion parameter setting process when an electronic original writer 102 can set details of conversion operation in conversion operation of step S902. When the user wants to create an electronic original file by designating details of conversion operation, e.g., “output paper size”, “paper direction”, “margin”, “resolution”, “input original size”, “font”, “compression operation”, “drawing operation”, and “color”, conversion parameters are designated using a conversion parameter setting UI at an arbitrary timing in advance. These settings simultaneously become effective in one conversion, and a set of settings (to be referred to as a conversion parameter group) or a plurality of conversion parameter groups can be set together with their use conditions. This process is schematically shown in the flowchart of FIG. 15.

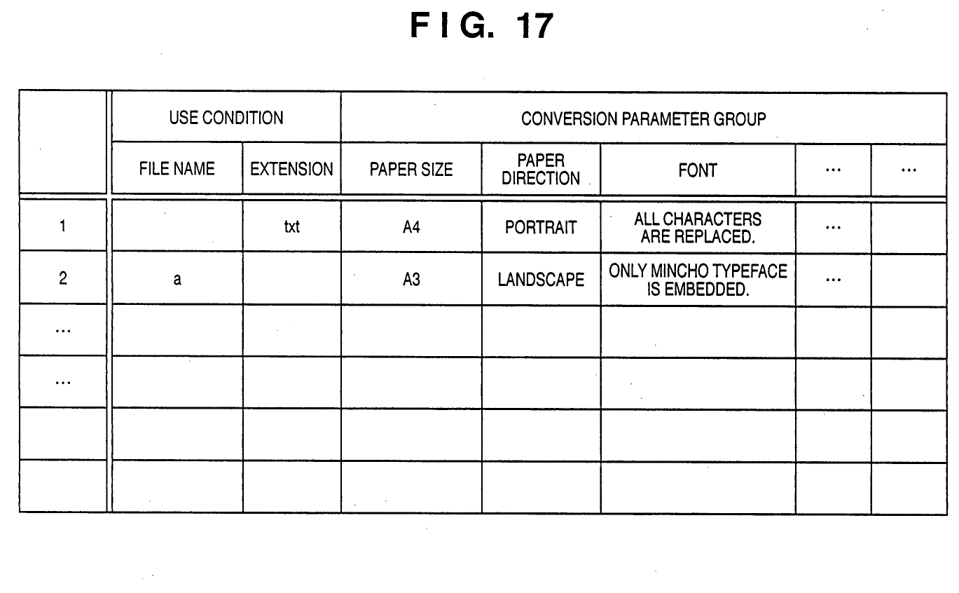

The user designates to display a conversion parameter setting UI from a bookbinding application UI, and starts setting (S1401). As another embodiment, the conversion parameter setting UI may be displayed from an electronic original writer UI. If the user ends arbitrary setting (S1402), the bookbinding application or electronic original writer 102 records setting values designated by the user in an HD (211) or RAM (202) (S1403). Each conversion parameter group is recorded as information shown in FIG. 17 together with its use condition. That is, one conversion parameter group is set for each condition.

The sequence of FIG. 15 is similar to that of FIG. 13 in the first embodiment. However, in step S1401, unlike FIG. 13, conversion parameters can be set for each condition, which will be explained with reference to FIG. 17. As “use condition”, “file name” and “extension” can be set. Conversion parameter group 1 does not have any designated file name, and the extension is set as “txt”. That is, a conversion source file having the extension “txt” corresponds to conversion parameter group 1 regardless of the name of the conversion source file, and is converted into electronic original data by using the conversion parameters. Conversion parameter group 2 has a file name setting “a*”, and no extension is set. That is, a conversion source file whose name starts from “a” corresponds to conversion parameter group 2 regardless of the extension, and is converted into electronic original data by using the conversion parameters. Although not shown in FIG. 17, a conversion parameter group used in converting a file which does not meet any condition is also registered as a default value in the lowermost column. Default values can be decided similarly to the first embodiment.

In setting a conversion parameter group in step S1401, the user inputs a file name and extension as a use condition, and then inputs a conversion parameter group. After the end of inputting one conversion parameter group, the user repeats input of the next conversion parameter group from setting of the use condition. Finally, these pieces of information are stored in a memory or hard disk in the format as shown in FIG. 17.

The use condition is not limited to the file name and extension. For example, an attribute value recorded at the header of a file or the like can also be designated. For example, the creator name and title of a conversion source file may also be designated as a use condition. An application program name corresponding to conversion source application data may also be designated as a use condition.

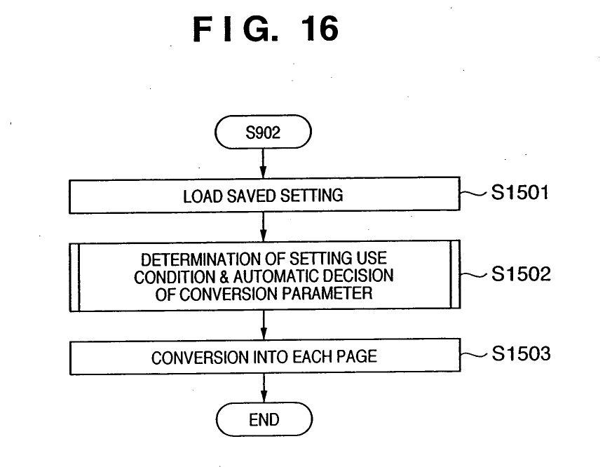

In conversion operation of step S902 by the electronic original writer 102, the electronic original writer 102 loads a use condition set by the user in accordance with the sequence of FIG. 15 and a corresponding conversion parameter group table, as shown in FIG. 16 (S1501). The electronic original writer 102 determines the setting use condition by comparing it with attributes such as the name and extension of a conversion source file. As a result, the electronic original writer 102 automatically decides conversion parameters for use, and decides parameters in conversion in accordance with the setting (S1502). The electronic original writer 102 converts the file into electronic original data by using the determined conversion parameters (S1503).

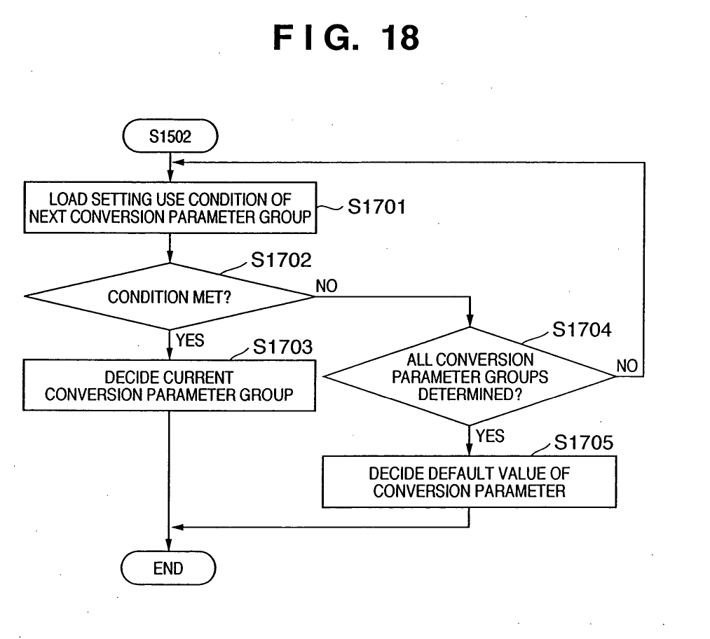

FIG. 18 is a flowchart showing in detail a use condition determination & conversion parameter decision process in step S1502 of FIG. 16. When determination of the setting use condition starts, the conversion parameter group table saved in S1403 of FIG. 15, i.e., use conditions and corresponding conversion parameters are loaded, and attention is given to the first use condition (S1701). Whether the conversion source file meets the condition of interest is determined (S1702). Available examples of the determination condition are the file name of application data to be converted, the file extension of application data, and an application name corresponding to designated application data. If the conversion source file meets the condition upon determination, a conversion parameter group corresponding to the currently loaded use condition is decided as a conversion parameter group used for the current conversion (S1703). If the conversion source file does not meet the condition upon determination, whether the use conditions of all parameter groups have been determined is determined (S1704). If NO in S1704, attention is given to the determination condition of the next conversion parameter group, and the process continues. If the use conditions of all parameter groups have been determined, default values set in the program in advance are decided as a conversion parameter group used for the current conversion (S1705). When use condition determination is executed from the start of the table, conversion parameters registered in an upper column of the table are preferentially employed for a file which meets a plurality of use conditions.

Electronic original data is generated by the electronic original writer 102 in accordance with the decided conversion parameters, and saved as a permanent file 103. The electronic original file can be generated with more preferable user settings. Some conversion source files are divided into pages or records, and contained character data and the like have fonts, sizes, and positions which have already been designated. Some conversion source files are not divided into pages, but character data have designated fonts and sizes, like an HTML document. For such conversion source file, a condition for specifying it is set, and only undesignated conversion parameters are registered in correspondence with the condition. Only for the undesignated settings, the user can designate desirable settings.

According to the second embodiment, which of a plurality of settings is to be used can always automatically be decided in the sequence of generating an electronic original file by the electronic original writer 102. When an electronic original file is generated by drag-and-drop operation, conversion can be done using proper conversion parameters corresponding to the condition of an original file.

### Third Embodiment

In the second embodiment, which of a plurality of settings is to be used can always automatically be decided in the sequence of generating an electronic original file by the electronic original writer 102. In the third embodiment, when an electronic original file is to be generated by drag-and-drop operation of application data, a selection UI can be displayed to automatically decide conversion parameters in accordance with determination of the setting use condition or allow the user to directly designate one of conversion parameter groups. The third embodiment will be described in detail below with reference to the accompanying drawings.

The basic configuration is the same as those shown in FIGS. 1, 2 and 11 in the first and second embodiments. A description of parts having the same configurations as those in the first and second embodiments will be omitted.

When the user wants to create an electronic original file by designating details of conversion operation, e.g., “output paper size”, “paper direction”, “margin”, “resolution”, “input original size”, “font”, “compression operation”, “drawing operation”, and “color”, conversion parameters and their use condition are designated using a conversion parameter setting UI at an arbitrary timing in advance. These settings simultaneously become effective in one conversion, and a set of settings (to be referred to as a conversion parameter group) or a plurality of conversion parameter groups can be set. This process is schematically shown in FIG. 15. The user designates to display a conversion parameter setting UI from a bookbinding application UI, and starts setting (S1401). As another embodiment, the conversion parameter setting UI may be displayed from an electronic original writer UI. If the user ends arbitrary setting (S1402), the bookbinding application or electronic original writer records setting values designated by the user in an HD (211) or RAM (202) (S1403). The respective parameter groups are stored as information shown in FIG. 17.

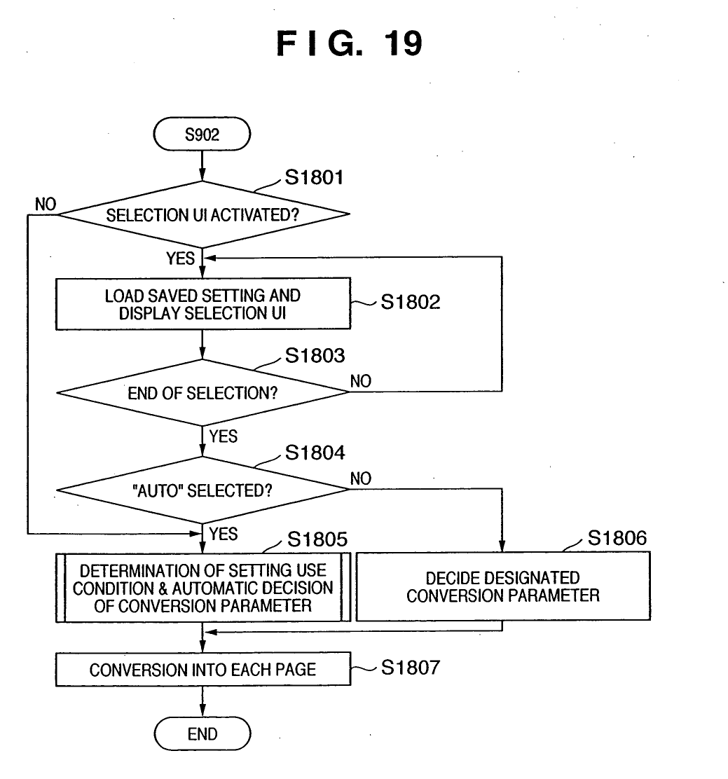

FIG. 19 is a flowchart showing a conversion parameter setting process when an electronic original writer 102 is activated by drag-and-drop operation of application data in conversion operation of step S902. In conversion, the user decides whether a conversion parameter group is designated directly by the user or selected automatically. The user explicitly designates whether to activate the selection UI. As the designation method, activation can be designated by keeping pressing a specific key of a keyboard 209 in drag and drop, or by drag and drop with the right button of a mouse (not shown in FIG. 2). In any case, activation of the selection UI is designated simultaneously when drag-and-drop operation instructs the electronic original writer 102 to start conversion.

The electronic original writer 102 receives this instruction (S1801). If activation of the selection UI is designated, the electronic original writer 102 displays the selection UI (S1802), and if no activation is designated, conversion parameters are automatically decided (S1805). This process is the same as those in the first and second embodiments.

If the user designates activation of the selection UI, the electronic original writer 102 loads a conversion parameter group table set by the user in advance in accordance with the sequence of FIG. 15. The electronic original writer 102 further adds “auto” as a selection candidate, and displays conversion parameter groups as selection candidates on the UI (S1802). For example, identifiers corresponding to conversion parameter groups and “auto” are presented as selection candidates to the user. If the user selects one of the selection candidates (S1803), the selected item is determined (step S1804). If “auto” is selected, the setting use condition is determined in accordance with the flowchart of FIG. 18 to decide a parameter group in conversion (S1805). If another candidate is selected, the selected conversion parameter group is decided as parameters in conversion (S1806).

An electronic original file is generated by the electronic original writer in accordance with the decided conversion parameters (S1807). In this way, the electronic original file can be generated with more preferable user settings.

According to the third embodiment, conversion parameters can be automatically selected or decided in accordance with the current intention of the user. This can further enhance the flexibility of the conversion parameter decision sequence. The selection UI can be activated at the same time as drag-and-drop operation without impairing the operability.

According to the invention of the above embodiments, electronic original data can be created in accordance with a conversion parameter group having undergone desired setting by the user in advance in creating the electronic original data. This invention is effective in creating electronic original data by drag and drop.

### Other Embodiment

The present invention may be applied to a system including a plurality of devices (e.g., a host computer, interface device, reader, and printer) or an apparatus (e.g., a copying machine or facsimile apparatus) formed by a single device.

The object of the present invention is also achieved when a storage medium (or recording medium) which stores software program codes in the sequences shown in FIGS. 11, 13, 14, 15, 16, 18, and 19 for realizing the functions of the above-described embodiments is supplied to a system or apparatus, and the computer (or the CPU or MPU) of the system or apparatus reads out and executes the program codes stored in the storage medium. In this case, the program codes read out from the storage medium realize the functions of the above-described embodiments, and the storage medium which stores the program codes forms the present invention. The functions of the above-described embodiments are realized when the computer executes the readout program codes. Also, the functions of the above-described embodiments are realized when an operating system (OS) or the like running on the computer performs some or all of actual processes on the basis of the instructions of the program codes.

Furthermore, the functions of the above-described embodiments are realized when the program codes read out from the storage medium are written in the memory of a function expansion card inserted into the computer or the memory of a function expansion unit connected to the computer and the CPU of the function expansion card or function expansion unit performs some or all of actual processes on the basis of the instructions of the program codes.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2003-302004, filed on Aug. 26, 2003, the entire contents of which are incorporated herein by reference.

1. A document conversion method of converting an original data file into a document file formed from an electronic original of each page, comprising:
a setting step of prompting a user to set conversion parameters for attributes of the original document file and storing the conversion parameters; and
a conversion step of converting the original data file into the electronic original in accordance with a conversion parameter selected from the conversion parameters set in the setting step.

2. The method according to claim 1, further comprising, prior to the conversion step, a selection step of selecting a conversion parameter in accordance with designation of the user, in the setting step, the user being prompted to set a plurality of sets of conversion parameters and the plurality of sets of conversion parameters being stored, and in the conversion step, conversion being performed in accordance with a conversion parameter selected in the selection step from the plurality of conversion parameters.

3. The method according to claim 2, wherein in the setting step, the user is prompted to set the plurality of sets of conversion parameters in association with the attributes of the file and the plurality of sets of conversion parameters are stored, and in the selection step, the user is prompted to select whether to select the conversion parameter in accordance with designation of the user or to perform conversion in accordance with the conversion parameter associated with the attribute of the original data file.

4. A document conversion method of converting an original data file into a document file formed from an electronic original of each page, comprising:
a setting step of prompting a user to set a plurality of sets of conversion parameters in association with attributes of the file and storing the plurality of sets of conversion parameters; and
a conversion step of converting the original data file into the electronic original in accordance with a conversion parameter associated with an attribute of the original data file among the plurality of conversion parameters set in the setting step.

5. The method according to claim 4, wherein the attribute of the file includes at least one of a file name and an extension.

6. The method according to claim 1, wherein in the conversion step, the original data file is converted into the document file formed from the electronic original of each page by drag-and-drop operation of the original data file to a predetermined location by using a graphical user interface.

7. The method according to claim 1, wherein the conversion parameter includes both or one of a paper attribute including a size and a direction and a character attribute including a size and a font.

8. A document conversion apparatus which converts an original data file into a document file formed from an electronic original of each page, comprising:
setting means for prompting a user to set conversion parameters and storing the conversion parameters; and
conversion means for converting the original data file into the electronic original in accordance with a conversion parameter selected from the conversion parameters set by said setting means.

9. A document conversion apparatus which converts an original data file into a document file formed from an electronic original of each page, comprising:
setting means for prompting a user to set a plurality of sets of conversion parameters in association with attributes of the file and storing the plurality of sets of conversion parameters; and
conversion means for converting the original data file into the electronic original in accordance with a conversion parameter associated with an attribute of the original data file among the plurality of conversion parameters set by said setting means.

10. A computer-readable recording medium which records a program for converting an original data file into a document file formed from an electronic original of each page, wherein the program comprises
setting code means for prompting a user to set conversion parameters and storing the conversion parameters, and
code means for converting the original data file into the electronic original in accordance with a conversion parameter selected from the conversion parameters set by said setting code means.

11. A computer-readable recording medium which records a program for converting an original data file into a document file formed from an electronic original of each page, wherein the program comprises
setting code means for prompting a user to set a plurality of sets of conversion parameters in association with attributes of the file and storing the plurality of sets of conversion parameters, and
conversion means for converting the original data file into the electronic original in accordance with a conversion parameter associated with an attribute of the original data file among the plurality of conversion parameters set by said setting code means.
